(19) United States
(12) Patent Application Publication
(10) Pub. No.: US 2009/0065249 A1
(43) Pub. Date: Mar. 12, 2009

(54) Marine Wire Organizer

(76) Inventor: Robert Martin Silvers, Subic Bay Freeport Zone (PH)

Correspondence Address: ROBERT SILVERS, PO BOX 128, SUBIC BAY FREEPORT ZONE, 2222, PH

(21) Appl. No.: 11/852,264

(22) Filed: Sep. 7, 2007

(51) Int. Cl. H02G 3/04

(52) U.S. Cl. 174/72 A

(57) ABSTRACT

A marine wire organizer intended for retaining and organizing a plurality of wires associated with various maritime vessels. The wire organizer has a series of spaced slots with corresponding notches through which wires of variable sizes and cross-sectional areas can be easily inserted leading to transverse holes that receive and retain the wires at stable positions, and has two layers of adhesive material on the base plane thereof. The wire organizer is made of a material with compression recovery characteristics enabling it to return to its original shape after it has been compressed during insertion of wires thereby holding the wires in place. With its flexible material, the marine wire organizer is capable of following the contour of the surface, flat or curved, to which it can be attached. The first of the two layers of adhesive material on the base plane of the marine wire organizer has less adhesive strength intended for temporary attachments, and the second layer has more adhesive strength for permanent installation.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of Invention

The present invention generally relates to a wire-organizing device intended for holding and retaining a plurality of insulated wires in maritime vessels.

2. Prior Art

The problem of organizing the wires of electrical and technical equipment is apparent in places with limited spaces like in boats, ships, yachts and dinghies. One common practice is that the wires are tied into a bundle and hidden in the bilge, behind wall panels or in the bulkhead of the marine vessel. These wirings often run the length of the vessel, with individual wires entering and exiting the cable run at odd intervals. Most of what is currently used are straps and bundling ties similar to those revealed in U.S. Pat. Nos. 4,780,935, 5,075,932, 5,168,603 and 6,425,165. This method of bundling wires becomes particularly inconvenient in refurbishing these maritime vessels, wherein frequent replacement or relocation of equipment involves tracing of existing wires, removing some obsolete wires and adding some new wires from the updated fixtures. This entails cutting the straps or ties that hold the bundle of wires together and tracing the wire sought to be removed from the bundle and putting back the wires together.

At present, there is no wire-organizing device available for marine application. The only way to solve the problem of bundling and unbundling wires and to achieve easy wire access in a vessel is to individually mount the wires using wire-holding devices which consist of individual bases with wire receptacles. Aforementioned structure is revealed by U.S. Pat. Nos. 4,285,486, 4,588,153, 5,425,518 and 5,441,224. While this method of using individual wire-holding devices meets the goal of easy access, these devices can be difficult to work with in tight spaces and consumes a lot of time to install which usually requires the use of assorted tools like clip, staple, or threaded fastener. Reinstallation of these individual bases to a different location, when relocating equipment, likewise involves a tedious effort. Another problem encountered in most maritime vessels is the installation of these wire supports in surfaces that are not flat. In a vessel, wiring harnesses typically run along the inner side of the hull. Since the hull is generally curved in shape, traditional methods of securing wires can be difficult. Not only are the surfaces inside a maritime vessel irregular, there are also hard-to-reach areas, due to the tight space, which makes installation of traditional wire supports especially difficult. Most light vessels are made of thin materials which do not allow the use of screws and other mechanical fasteners in installing wire-holding devices. Moreover, the use of traditional wire-holding devices permanently installed inside a maritime vessel can be unwise as the vessel usually encounters rough sea. Wires permanently and tightly held by traditional wire holders would easily snap once hit by another object inside the vessel during rough sea.

While many attempts had been made in the past to provide a device for generally holding, securing, and organizing wires, few, if any, provide a simple and convenient way to precisely hold, secure, and organize wires in place. Further, most of such devices had somewhat complicated installations and use expensive materials and manufacturing processes.

### SUMMARY OF THE INVENTION

Accordingly, the inconvenience in securing and organizing wires is addressed by the present invention that provides a marine wire organizer intended for organizing a plurality of wires that can be fixed on either flat or curved surface of a maritime vessel. The wire organizer has a series of spaced slots with corresponding notches through which wires of variable sizes and cross-sectional areas can be easily inserted leading to transverse holes that receive and retain the wires at stable positions to prevent dislodging.

The wire organizer takes full advantage of the compression recovery characteristics of the material it is made of enabling it to return to its original shape after insertion of wire thereby holding the wire in place. The flexibility of the material used likewise facilitates the effortless replacement or alteration of wires. With its flexible material, the wire organizer is capable of following the contour of the surface to which it may be attached.

The marine wire organizer is made of a material which is both resistant to chemical reactions and corrosion from natural elements. The said material is likewise non-conductive of electricity thus preventing electric shocks.

For installation, the marine wire organizer has two layers of water-resistant adhesive material disposed on its base plane, wherein the first layer has less adhesive strength intended for temporary attachments, and the second layer with more adhesive strength is used for installation in a permanent location. The two layers of water-resistant adhesive material disposed on the base plane of the wire organizer each has corresponding releasing liner disposed overtop each adhesive layer. A corresponding releasing liner is disposed overtop the first layer of adhesive material with less adhesive strength, while the latter is disposed overtop another releasing liner corresponding to and disposed overtop the second adhesive layer which has more adhesive strength. The second adhesive layer is disposed directly overtop the base plane of the marine wire organizer. For more elaborate wire installations, the marine wire organizer has a rectangular form with flat surfaces which allow the stacking of one wire organizer over another thereby creating layers of organized wires.

The marine wire organizer comes in a rolled form. This is intended for convenient packaging and storage. More importantly, the marine wire organizer presented in a rolled form achieves versatility by allowing the user to determine its length as needed. For installation, a portion of a roll of marine wire organizer can simply be unrolled and cut according to the desired length depending on the number of wires to be organized and the area of the surface on which the wires are to be mounted.

It is therefore the primary object of the present invention to provide a simple solution to the problem of securing, organizing and tracing wires by providing a marine wire organizer that is capable of retaining wires of different sizes and cross-sectional areas in an organized fashion, and can be fixed on any surface (including those made of thin materials) and on hard-to-reach areas in a maritime vessel.

Another object of the present invention is to provide a marine wire organizer enabling wires to be managed not only in an organized fashion, but likewise aesthetically pleasing as the wires are organized in a manner which follows the sinuousity of the boat's surface.

Another object of the present invention is to provide a marine wire organizer made of low cost material with simplicity in functionality and is economical to manufacture, thus, can be made disposable.

Further, the present invention intends to provide a wire-organizing device which reduces the extensive labor usually associated with the installation of traditional wire supports by presenting it in a rolled form wherein it can just be easily unrolled and cut in desired lengths according to the number of wires to be organized, and be easily installed by means of the adhesive layer.

### BRIEF DESCRIPTION OF THE DRAWING

The features of the present invention which are believed to be novel are set forth with particularity in the appended claims. The structure and mode of operation of the present invention is further elucidated in the following descriptions, relating to the accompanying drawings, to wit:

FIG. 1 is a perspective view showing the marine wire organizer having plurality of slots with corresponding notches leading to transverse holes, and having two layers of adhesive material.

FIG. 2 is a perspective view showing the base plane of the marine wire organizer having two layers of adhesive material of different adhesive strengths and their corresponding releasing liners.

FIG. 3 is an exploded perspective view showing the marine wire organizer holding and retaining plurality of wires in the transverse holes.

FIG. 4 is a side longitudinal view of the marine wire organizer holding and retaining wire in a transverse hole.

FIG. 5 is a fragmentary top plan view of the marine wire organizer holding and retaining plurality of wires in transverse holes.

FIG. 6 is a sectional view, on an enlarged scale, of the marine wire organizer illustrating the insertion of wire passing through a slot with a notch leading to a transverse hole.

FIG. 7 is a sectional view, on an enlarged scale, of the marine wire organizer firmly retaining a wire in a transverse hole.

FIG. 8 is a sectional view, on an enlarged scale, of the marine wire organizer loosely retaining an insulated wire in a transverse hole.

FIG. 9 is a fragmentary perspective view of the marine wire organizer illustrating an alternative version with respect to the present invention.

FIG. 10 is a fragmentary perspective view of the marine wire organizer illustrating an alternative version with respect to the present invention.

FIG. 11 is a fragmentary perspective view of the marine wire organizer illustrating an alternative version with respect to the present invention.

FIG. 12 is a perspective view of several pieces of the marine wire organizer attached to a wall surface holding and organizing plurality of wires.

FIG. 13 is a perspective view of several pieces of the marine wire organizer mounted on a surface with one pair stacked or mounted on top of the other pair, showing two layers of organized wires.

FIG. 14 is a side view of a single piece of marine wire organizer presented in a rolled form.

### DETAILED DESCRIPTION OF THE PREFERRED EMBODIMENTS

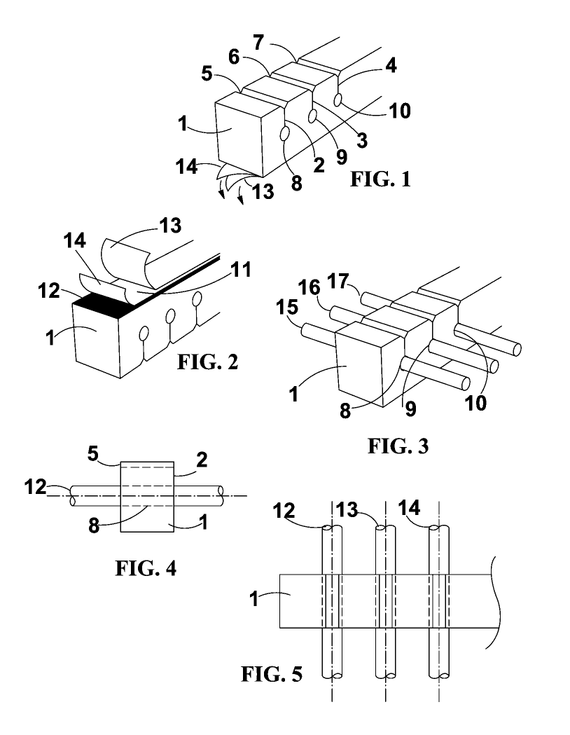

Referring to FIG. 1, a marine wire organizer is illustrated by numeral 1 which consists of a series of slots indicated by numerals 2, 3 and 4 with notches identified by numerals 5, 6 and 7 leading to circular transverse holes specified by 8, 9 and 10. Notches 5, 6 and 7 serve as wide openings of slots 2, 3 and 4 that allow easy insertion of wires. Slots 2, 3 and 4, through which wires of different diameters and cross-sectional areas may be inserted, lead to transverse holes 8, 9 and 10 that hold and retain the wire in place. The base plane of marine wire organizer 1 has two releasing liners indicated by numerals 13 and 14 disposed overtop two layers of adhesive material. Marine wire organizer 1 is made of any material known in the art which has compression recovery characteristics, and with smooth textured surface that allows easy adjustment of wires.

Referring to FIG. 2, the marine wire organizer 1 has the two layers of adhesive material with different adhesive strengths and their corresponding releasing liners. The first layer of adhesive material illustrated by numeral 11 has less adhesive strength intended for temporary attachments while the second layer of adhesive material illustrated by numeral 12 has more adhesive strength for permanent installation. The releasing liner 13 is disposed overtop adhesive layer 11, while releasing liner 14 is disposed overtop adhesive layer 12.

Referring to FIG. 3, marine wire organizer 1 has transverse holes 8, 9 and 10 that hold and retain insulated wires indicated by numerals 15, 16 and 17 in place. FIG. 4 shows the side longitudinal view of FIG. 3 while FIG. 5 shows the top plan view of FIG. 3.

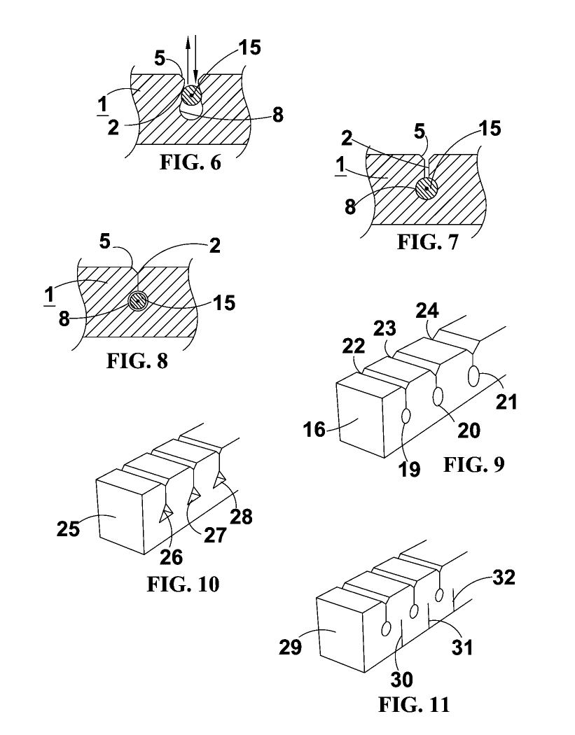

Referring to FIG. 6, the insertion of insulated wire 15 passing through slot 2 leading to transverse hole 8 can be clearly recognized by the directed arrow. The compression recovery characteristics of the material used in the marine wire organizer enables it to return to its original shape after it has been compressed. In the operation of this invention, compression occurs in the process of wire insertion in the slot leading to a transverse hole that will receive the wire. After the inserted wire reaches the transverse hole, the marine wire organizer returns to its original shape and thereby securing the wire in place.

Referring to FIG. 7, transverse hole 8 firmly holds and retains wire 15 with the same or greater diameter than that of transverse hole 8.

Referring to FIG. 8, transverse hole 8 may loosely hold but still retain insulated wire 15 with a smaller diameter than that of transverse hole 8.

Referring to FIG. 9, an alternative version of a marine wire organizer is illustrated by numeral 18 containing transverse holes of different diameters indicated by numerals 19, 20 and 21 that can accommodate insulated wires of different diameters and cross-sectional areas. The opening of the notches indicated by numerals 22, 23 and 24 also vary according to the diameters of the transverse holes connected to slots.

Referring to FIG. 10, another alternative version of a marine wire organizer illustrated by numeral 25 has a series of spaced slots with corresponding notches leading to triangular transverse holes indicated by numerals 26, 27 and 28 that can accommodate wires of different shapes.

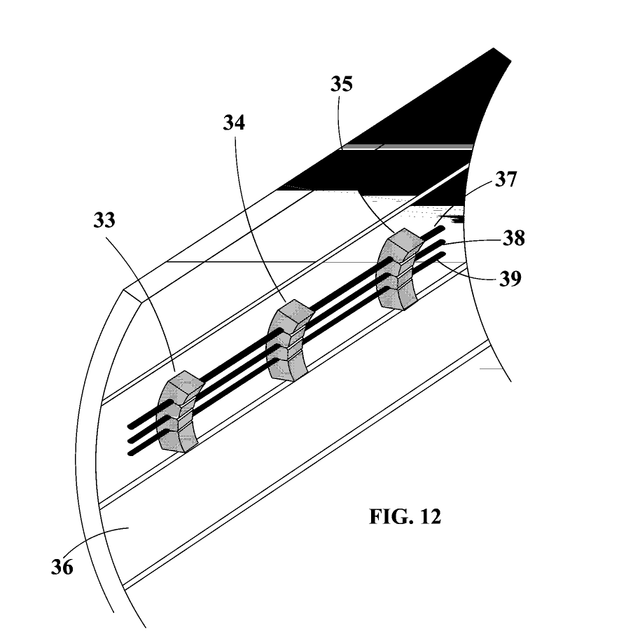

Referring to FIG. 11, another alternative version of a marine wire organizer illustrated by numeral 29 has a series of spaced slots on the top plane with corresponding notches leading to transverse holes. Another series of spaced slots indicated by numerals 30, 31 and 32 can be placed at the bottom plane parallel to the top plane thereof to enhance its flexibility, thus, enabling the wire organizer to be fixed on curved surfaces.

Referring to FIG. 12, several pieces of the marine wire organizer illustrated by numerals 33, 34, and 35 are mounted on an inner surface of a boat indicated by numeral 36. This figure reveals wires illustrated by numerals 37, 38, and 39 being held securely in an organized fashion.

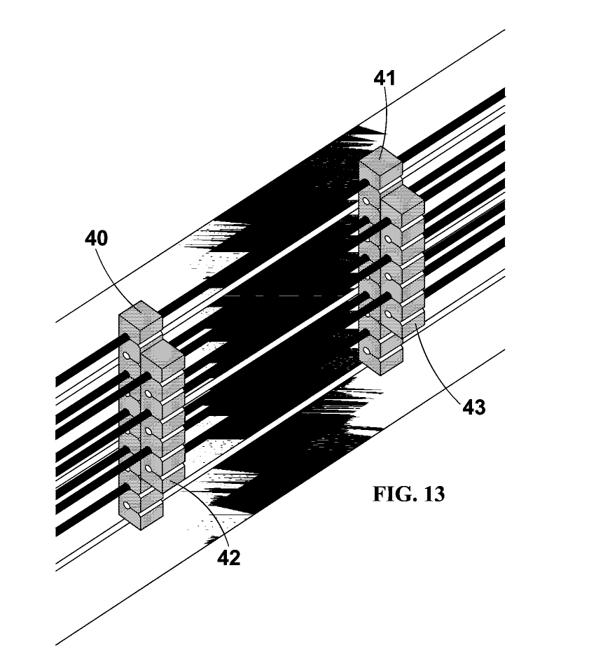

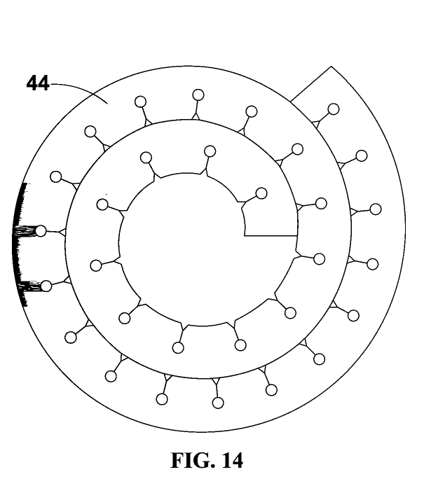

Referring to FIG. 13, several pieces of marine wire organizers illustrated by numerals 40, 41, 42 and 43 are mounted on a surface with one pair stacked or mounted on top of the other pair, showing two layers of organized wires.

Referring to FIG. 14, a single piece of marine wire organizer illustrated by numeral 44 is presented in a rolled form.

It will be apparent to those skilled in the art that various modifications can be made to the present invention which may still be deemed to be within the intent and scope of the invention. Thus, it is proposed that the present invention likewise cover these possible modifications as long as the same are within the scope of the claims and their equivalents.

I claim:

1. A marine wire organizer comprising a rectangular body of flexible material having a series of spaced slots with corresponding notches through which wires of variable sizes and cross-sectional areas can be inserted leading to transverse holes that receive and retain the wires at stable positions, and having two layers of water-resistant adhesive material disposed on the base plane thereof.

2. The marine wire organizer in claim 1 wherein said flexible material has compression recovery characteristics enabling the wire organizer to return to its original shape after it has been compressed during insertion of a wire thereby holding said wire in place.

3. The marine wire organizer in claim 1 wherein said flexible material enables the wire holder to follow the contour of the surface, flat or curved, to which it can be attached.

4. The marine wire organizer in claim 1 wherein said flexible material is both resistant to chemical reactions and corrosion from natural elements, and non-conductive of electricity.

5. The marine wire organizer in claim 1 wherein the first of the said two layers of water-resistant adhesive material disposed on its base plane has less adhesive strength intended for temporary attachments, and the second layer has more adhesive strength for permanent installation.

6. The marine wire organizer in claim 1 wherein the said two layers of water-resistant adhesive material disposed on its base plane each has corresponding releasing liner disposed overtop each adhesive layer. A corresponding releasing liner is disposed overtop the first layer of adhesive material with less adhesive strength, while the latter is disposed overtop another releasing liner corresponding to and disposed overtop the second layer of adhesive material which has more adhesive strength. The second layer of adhesive material is disposed directly overtop the base plane of the marine wire organizer in claim 1.

7. The marine wire organizer in claim 1 wherein the said rectangular form of flexible material has flat surfaces which allows the stacking of one wire organizer over another thereby creating layers of organized wires for more elaborate wire installations.

8. The marine wire organizer in claim 1 wherein the marine organizer is in a rolled form.
